(19) United States
(12) Patent Application Publication
(10) Pub. No.: US 2026/0057428 A1
(43) Pub. Date: Feb. 26, 2026

(54) FACILITATING GROUP SHOPPING VIA AN ELECTRONIC DEVICE

(71) Applicant: MOTOROLA MOBILITY LLC, WILMINGTON, DE (US)

(72) Inventors: KRISHNAN RAGHAVAN, BANGALORE (IN); NAKUL PATEL, NAGPUR (IN); ASHOK OLIVER PRABHU, TIRUCHIRAPALLI (IN)

(21) Appl. No.: 18/812,048

(22) Filed: Aug. 22, 2024

(51) Int. Cl. G06Q 30/0601

(52) U.S. Cl. CPC G06Q 30/0629; G06Q 30/0631

(57) ABSTRACT

An electronic device, method, and computer program product enable coordination of shopping by members of a collaborative shopping group by generating useful notifications about potential product/service purchases that are reviewed by others within the group. The method includes detecting a trigger indicative of an item review context that includes presentation of at least one first item having a first merchandise category tracked within a collaborative shopping group context. In response to the trigger, collaborative shopping data corresponding to at least one previously-viewed first item is retrieved. The method includes determining if the at least one previously-viewed first item has received a first classification by at least one member of a collaborative shopping group. In response to the previously-viewed first item having received the first classification, the method includes outputting a first message indicating the first classification concurrently with presenting the at least one first item.

### BACKGROUND

### 1. Technical Field

The present disclosure generally relates to electronic devices and in particular to using electronic devices to facilitate online shopping.

### 2. Description of the Related Art

Electronic devices, such as mobile phones, tablets, and laptops, are widely used for video, voice, and text communication and for data transmission. Online shopping has also become a popular use for these mobile electronic devices. Online shopping is a form of electronic commerce that allows consumers to purchase goods or services using an electronic device. Consumers can find a product of interest by visiting retailer websites or by using a search engine that displays the availability and price of a product at different merchants. The consumer can then complete the purchase of the product using their electronic device.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example electronic device within which various aspects of the disclosure can be implemented, according to one or more embodiments;

FIG. 2 is an example illustration of the electronic device of FIG. 1 transmitting a request for collaborative shopping data to an application computer system and receiving a response from the application computer system, according to one or more embodiments;

FIGS. 3A and 3B are block diagrams of example contents of the system memory of the example electronic device of FIG. 1 configured to complete the various processes described herein, according to one or more embodiments;

FIG. 4A is an example illustration of a display of an electronic device presenting a graphical user interface (GUI) that includes an option to establish a collaborative shopping group, according to one or more embodiments;

FIG. 4B is an example illustration of a display of an electronic device presenting a GUI to select one or more members of a collaborative shopping group, according to one or more embodiments;

FIG. 5A is an example illustration of a display of an electronic device presenting an online item selection interface GUI for reviewing and selecting items for possible acquisition by members of a collaborative shopping group, according to one or more embodiments;

FIG. 5B is an example illustration of a display of an electronic device presenting a filter selection GUI for selecting one or more filter types to be applied to the online item selection interface GUI of FIG. 5A, according to one or more embodiments;

FIG. 5C is an example illustration of a display of an electronic device presenting an online item selection interface GUI after the filter of FIG. 5B has been applied, according to one or more embodiments;

FIG. 6 is an example illustration of a display of an electronic device presenting an online item selection interface product page GUI for reviewing details and selecting an item for possible acquisition by members of a collaborative shopping group, according to one or more embodiments;

FIG. 7 is an example illustration of a display of an electronic device presenting a classification selection GUI to select one or more classifications for at least one item, according to one or more embodiments;

FIG. 8 depicts a flowchart of a method by which an electronic device coordinates shopping and reviewing of items with members of a collaborative shopping group and generates notifications about at least one item, according to one or more embodiments;

FIG. 9 depicts a flowchart of a method by which an electronic device receives a selection by a user of at least one classification of a viewed item and updates a collaborative shopping database with the classification of the viewed item, according to one or more embodiments; and

FIG. 10 depicts a flowchart of a method by which an electronic device tracks a viewing time of at least one item by a user and identifies a classification for the item, if the viewing time is greater than a viewing time threshold, according to one or more embodiments.

### DETAILED DESCRIPTION

According to one or more aspects of the disclosure, the illustrative embodiments provide an electronic device, a method, and a computer program product for coordinating shopping with members of a collaborative shopping group and generating notifications about at least one item.

Products or items are often purchased together by couples, friends or groups of people via online shopping. The decision on which item to purchase can be a joint decision that is coordinated between several individuals. The item can be a product bought for themselves or a gift being purchased for others. There are occasions when one person of a group will have studied or reviewed an item and have identified the item as being a possible item for purchase or an item that is not suitable for purchase. Unfortunately, other members of the group are not able to view other member's opinions, thoughts, and reviews about an item. One member of the group may like an item and another member may dislike the same item. This can be problem as one member can spend a large amount of time researching an item that another member dislikes. Multiple members of the group may be looking at the same item, reading through product reviews of the item, and researching product specifications with one or more members eventually deciding that the item is not suitable to purchase. The present disclosure addresses and resolves the problem of a lack of coordinating information among a group of individuals that are collaboratively shopping for an item. The disclosure helps to eliminate situations where a same item is individually reviewed by different members of a group without knowledge that the other members have already reviewed the item. The disclosure provides benefits of time saving for the collective group and efficiency in identifying items suitable for purchase.

In a first embodiment, an electronic device includes at least one output device, a communications subsystem that enables the electronic device to connect to external networks and devices, and a memory having stored thereon a collaborative shopping module for coordinating shopping and generating notifications about at least one item. The electronic device includes at least one processor that is communicatively coupled to each of the at least one output device, the communications subsystem, and the memory. The at least one processor executes program code of the collaborative shopping module. The at least one processor is configured to cause the electronic device to detect a trigger indicative of an item review context that includes a presentation of at least one first item having a first merchandise category tracked within a collaborative shopping group context. In response to detecting the trigger, the at least one processor retrieves collaborative shopping data corresponding to at least one previously-viewed first item. The at least one processor determines if the at least one previously-viewed first item has received a first classification by at least one member of a collaborative shopping group. In response to the previously-viewed first item having received the first classification, the at least one processor outputs a first message concurrently with presenting the at least one first item. The first message indicates the first classification of the at least one previously-viewed first item.

According to another embodiment, the method includes detecting, via at least one processor, a trigger indicative of an item review context that includes a presentation of at least one first item having a first merchandise category tracked within a collaborative shopping group context. In response to detecting the trigger, the method includes retrieving collaborative shopping data corresponding to at least one previously-viewed first item. The method includes determining if the at least one previously-viewed first item has received a first classification by at least one member of a collaborative shopping group. In response to the previously-viewed first item having received the first classification, the method includes outputting a first message concurrently with presenting the at least one first item. The first message indicates the first classification of the at least one previously-viewed first item.

According to an additional embodiment, a computer program product includes a computer readable storage device having stored thereon program code that, when executed by at least one processor of an electronic device having at least one output device, and a communications subsystem, the program code enables the electronic device to complete the functionality of the above-described method processes.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

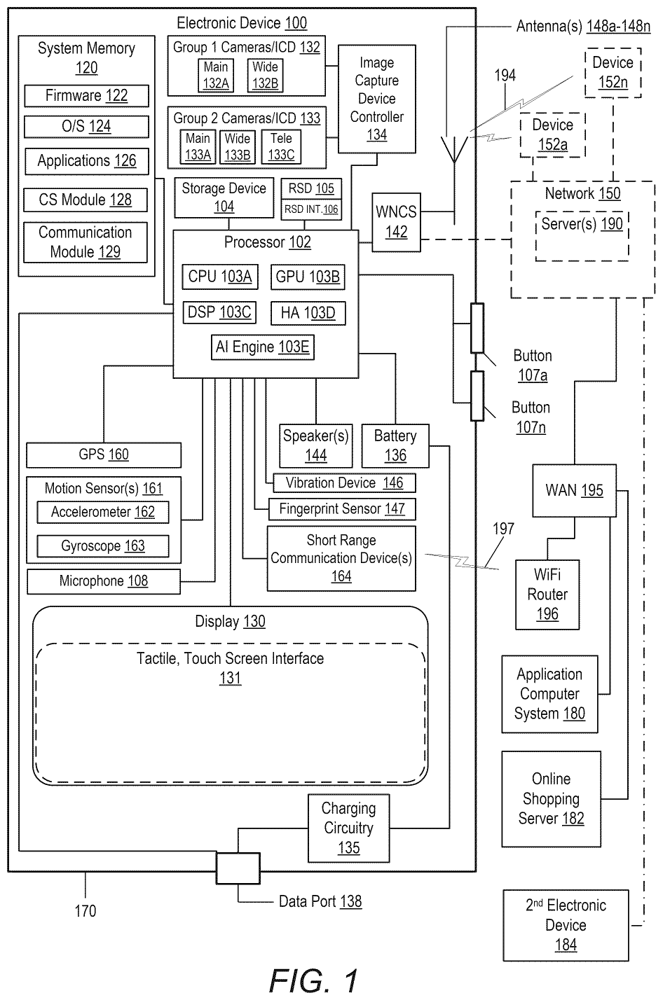

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

FIG. 1 depicts an example electronic device 100 within which various aspects of the disclosure can be implemented, according to one or more embodiments. Examples of such electronic devices include, but are not limited to, mobile devices, a notebook computer, a mobile phone, a digital camera, a smart watch, a tablet computer, and a communication device, etc. It is appreciated that electronic device 100 can be other types of devices that include the capability to transmit and receive communications. Electronic device 100 includes processor 102, which is communicatively coupled to storage device 104, system memory 120, input devices, (introduced below), output devices, such as display 130, and image capture device (ICD) controller 134. In one or more embodiments, the functionality of ICD controller 134 is incorporated within processor 102, eliminating the need for a separate ICD controller. For simplicity in describing the features presented herein, the various camera control functions performed by the ICD controller 134 are described as being provided generally by processor 102. Processor 102 can include processor resources such as a primary central processing unit (CPU) 103A that supports computing, classifying, processing and transmitting of data and information. Processor 102 can further include graphic processing units (GPU) 103B, digital signal processors (DSP) 103C, and hardware accelerator (HA) 103D that that also support computing, classifying, processing and transmitting and receiving of data and information. Processor 102 can further include a hardware based artificial intelligence (AI) engine 103E. AI engine 103E accelerates artificial intelligence, natural language processing (NLP), context evaluation (CE), and machine learning applications. AI engine 103E can also be implemented as a software module, in one embodiment.

System memory 120 may be a combination of volatile and non-volatile memory, such as random access memory (RAM) and read-only memory (ROM). System memory 120 can store program code and data associated with firmware 122, an operating system 124, applications 126, collaborative shopping (CS) module 128, and communication module 129. CS module 128 includes program code that is executable by processor 102 to enable electronic device 100 to setup or configure a collaborative shopping group, coordinate browsing, viewing and acquisition of at least one item among members of the collaborative shopping group. Communication module 129 includes program code that is executed by processor 102 to enable electronic device 100 to communicate with other external devices and systems.

Although depicted as being separate from applications 126, CS module 128, and communication module 129 may each be implemented as an application. Processor 102 loads and executes program code stored in system memory 120, including program code associated with applications 126 and program code associated with CS module 128 and communication module 129. When processed/executed by processor 102, the program code causes or configures electronic device 100 to provide the various functionality described herein.

In one or more embodiments, electronic device includes removable storage device (RSD) 105, which is inserted into an RSD interface 106 that is communicatively coupled via system interlink to processor 102. In one or more embodiments, RSD 105 is a non-transitory computer program product or computer readable storage device. In one or more embodiments, RSD 105 is a computer readable storage device encoded with program code and corresponding data, and RSD 105 can interchangeably be referred to as a non-transitory computer program product. RSD 105 may have a version of CS module 128 stored thereon, in addition to other program code. Processor 102 can access RSD 105 to provision electronic device 100 with program code that, when executed by processor 102, causes or configures electronic device 100 to provide the functionality described herein.

Display 130 can be one of a wide variety of display screens or devices, such as a liquid crystal display (LCD) and an organic light emitting diode (OLED) display. In some embodiments, display 130 can be a touch screen device that can receive user tactile/touch input. As a touch screen device, display 130 includes a tactile, touch screen interface 131 that allows a user to provide input to or to control electronic device 100 by touching features presented within/below the display screen. Tactile, touch screen interface 131 can be utilized as an input device.

Throughout the disclosure, the term image capturing device (ICD) is utilized interchangeably to be synonymous with and/or refer to any one of group 1 cameras/ICD 132, and group 2 cameras/ICD 133. As illustrated, electronic device 100 includes several group 1 cameras/ICD 132. Electronic device 100 further includes several group 2 cameras/ICD 133. In one embodiment, group 1 cameras/ICD 132 can be front cameras and group 2 cameras/ICD 133 can be rear cameras. Group 1 cameras/ICD 132 can include a main camera 132A and a wide angle camera 132B. Group 2 cameras/ICD 133 can include a main camera 133A, a wide angle camera 133B, and a telephoto camera 133C. Each group 1 camera 132A and 132B and each group 2 camera 133A, 133B and 133C is communicatively coupled to ICD controller 134, which is communicatively coupled to processor 102. ICD controller 134 supports the processing of signals from group 1 cameras 132A and 132B and group 2 cameras 133A, 133B, and 133C.

Electronic device 100 can further include charging circuitry 135, battery 136, and data port 138, for providing electrical power to the various electronic components of electronic device 100. Electronic device 100 further includes microphone 108, one or more output devices such as speaker 144, and one or more input buttons 107a-n. Input buttons 107a-n may provide controls for volume, power, and/or image capture devices 132, 133. Microphone 108 can also be referred to as audio input device 108. Microphone 108 can be used to provide biometric data to identify or authenticate a user. Microphone 108 and input buttons 107a-n can also be referred to generally as input devices. Speaker 144 can provide an audio alert to a user.

Electronic device 100 further includes wireless network communication subsystem (WNCS) 142, which is coupled to antennas 148a-148n. In one or more embodiments, WNCS 142 can include a communication module with one or more baseband processors or digital signal processors, one or more modems, and a radio frequency front end having one or more transmitters and one or more receivers. Wireless network communication subsystem (WNCS) 142 and antennas 148a-148n allow electronic device 100 to communicate wirelessly with wireless network 150 via transmissions of communication signals 194 to and from network communication devices 152a-152n, such as base stations or cellular nodes, of wireless network 150.

In one or more embodiment, wireless network 150 can include one or more servers 190 that support wireless exchange of voice, data, and video and other communication with electronic device 100. Wireless network 150 further allows electronic device 100 to communicate with application computer system 180, online shopping server 182, and second electronic device 184. Application computer system 180 and online shopping server 182 are communicatively coupled to wireless network 150 by a wide area network (WAN) 195, such as the Internet. In an embodiment, servers 190 of wireless network 150 support wireless exchange of e-mail, text, data, and other communications between electronic device 100 and application computer system 180 and online shopping server 182. In one embodiment, application computer system 180 and online shopping server 182 can provide data, information, and resources to electronic device 100 for use with applications 126 and CS module 128.

Second electronic device 184 is also communicatively coupled to wireless network 150. Second electronic device 184 can be similarly connected to wireless network 150, via one of network communication devices 152a-152n. In an embodiment, servers 190 of wireless network 150 support wireless exchange of voice, text, data, and video and other communication between electronic device 100 and second electronic device 184.

Electronic device 100 further includes short range communication device(s) 164. Short-range communication device 164 is a low powered transceiver that can wirelessly communicate with other devices. Short-range communication device(s) 164 can include one or more of a variety of devices supporting different corresponding wireless protocols, such as a near field communication (NFC) device, a Bluetooth device, and/or a wireless fidelity (Wi-Fi) device. Electronic device 100 can also connect wirelessly to wireless network 150 via communication signals 197 transmitted by short-range communication device(s) 164 to and from WiFi router 196, which is communicatively coupled to WAN 195, such as the Internet. Wireless network 150 is communicatively coupled to WAN 195.

Short-range communication device(s) 164 can wirelessly communicate with WiFi router 196 via communication signals 197. In one embodiment, electronic device 100 can receive Internet or Wi-Fi based calls via short-range communication device(s) 164. In one embodiment, electronic device 100 can communicate with WiFi router 196 wirelessly via short-range communication device(s) 164. In an embodiment, WNCS 142, antennas 148a-148n and short-range communication device(s) 164 collectively provide a communications subsystem of electronic device 100.

Electronic device 100 further includes vibration device 146, fingerprint sensor 147, global positioning system (GPS) 160, and motion sensor(s) 161. Vibration device 146 can cause electronic device 100 to vibrate or shake when activated. Vibration device 146 can be activated to provide an alert or notification to a user of electronic device 100. According to one aspect of the disclosure, display 130, speakers 144, and vibration device 146 can generally and collectively be referred to as output devices. These output devices can be each utilized to present different alerts to the user.

Fingerprint sensor 147 can be used to provide biometric data or images to identify or authenticate a user. GPS 160 can provide time data and location data about the physical location of electronic device 100. In one embodiment, GPS 160 uses data from geospatial input received from GPS satellites. Location information and data received from GPS 160 can be utilized to identify a location of an electronic device.

Motion sensor(s) 161 can include one or more accelerometers 162 and gyroscope 163. Motion sensor(s) 161 can detect movement of electronic device 100 and provide motion data to processor 102 indicating the spatial orientation and movement of electronic device 100. Accelerometers 162 measure linear acceleration of movement of electronic device 100 in multiple axes (X, Y and Z). For example, accelerometers 162 can include three accelerometers, where one accelerometer measures linear acceleration in the X axis, one accelerometer measures linear acceleration in the Y axis, and one accelerometer measures linear acceleration in the Z axis. Gyroscope 163 measures rotation or angular rotational velocity of electronic device 100. Electronic device 100 further includes a housing 170 that contains the components of electronic device 100.

In the description of each of the following figures, reference is also made to specific components illustrated within the preceding figure(s). Similar or same components are presented with the same leading reference number.

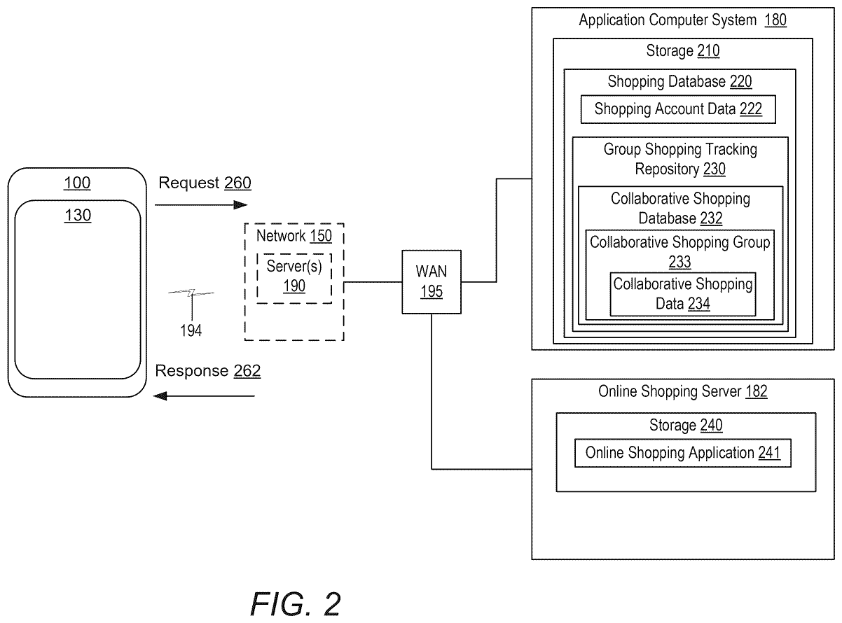

Turning to FIG. 2, with ongoing reference to FIG. 1, electronic device 100 is shown in communication with application computer system 180 and online shopping server 182. Electronic device 100 can communicate wirelessly with wireless network 150 via transmission and reception of communication signals 194. Communication network 150 includes communication servers 190 that are communicatively connected to a larger, wide area network (WAN) 195, such as the Internet. Electronic device 100 can also establish connection and communicate with wireless network 150 and with WAN 195 via WiFi router 196 and short-range communication device(s) 164 (FIG. 1).

Application computer system 180 and online shopping server 182 are communicatively coupled to a wide area network (WAN) 195, such as the Internet, to which server 190 of wireless network 150 is also communicatively coupled. In an embodiment, servers 190 of wireless network 150 support wireless exchange of e-mail, text, data, and other communication between electronic device 100 and application computer system 180 and online shopping server 182

Application computer system 180 can host one or more applications that provide various functions. In an example embodiment, application computer system 180 can host shopping applications, banking applications, and web browser applications. Application computer system 180 includes storage 210, such as one or more hard drives or solid state drives. Storage 210 can store (online) shopping database 220. Shopping database 220 can support one or more applications 126 of electronic device 100.

Shopping database 220 includes shopping account data 222 and group shopping tracking repository 230. Group shopping tracking repository 230 includes a collaborative shopping database 232, which stores collaborative shopping data 234 of collaborative shopping group 233. Shopping account data 222 can include user account data, merchant information, preferred payment methods, and preferred shipping/delivery methods. Collaborative shopping data 234 can include information about previously-viewed items that have been previously-viewed by members of collaborative shopping group 233.

Collaborative shopping group 233 can be a pre-determined group of individuals. In one embodiment, the pre-determined group of individuals can be family members or friends. In another embodiment, the pre-determined group of individuals can be employees of a business. In one or more embodiments, the user of electronic device 100 can be affiliated with a plurality of collaborative shopping group(s) 233 that each maintains separate collaborative shopping data 234. Collaborative shopping data 234 contains data and information that is shared and/or utilized by members of the group to coordinate and/or facilitate shopping.

In one embodiment, collaborative shopping data 234 can be updated with viewing information and/or one or more classifications based on viewing of the item by one or more members of collaborative shopping group 233. In one embodiment, an item can be classified by members of the collaborative shopping group after they have viewed the item. In an example embodiment, after viewing the item, a member of the collaborative shopping group may choose to label or classify the item as not being of interest (i.e., reject or ignore item). In another example embodiment, after viewing the item, a member of the collaborative shopping group may choose to label or classify the item as being of interest (i.e., add item to short list of possible items to purchase). In an additional example embodiment, after viewing the item, electronic device 100 can classify the item as having been viewed by a member of the collaborative shopping group (i.e., a user has considered the item). In one embodiment, the classification can be dynamically determined and automatically applied based on device tracking of the viewing habits and engagement with an item or a category of items by one or more members of the group.

In one or more embodiments, a review of items available for acquisition can be completed via online shopping server 182 that is communicatively connected to WAN 195. According to one aspect of the disclosure, electronic device 100 can transmit a request 260 to application computer system 180 for collaborative shopping data 234 with at least one previously-viewed item that has been viewed by a member of a collaborative shopping group. In one or more embodiments, initiation of at least one shopping application, by electronic device 100, which presents access to items having a common merchandise category with at least one first item can trigger transmission of request 260 to application computer system 180 for collaborative shopping data 234. The review of items available for acquisition and/or the initiation of at least one shopping application can both serve/operate as triggers that cause electronic device 100 to transmit request 260. Other triggers are possible, including detection of a log-on to a shopping website/portal, such as provided by online shopping server 182.

Electronic device 100 can receive, in response to the request 260, a response 262 that contains the collaborative shopping data 234 with at least one previously-viewed item. Electronic device 100 and application computer system 180 can perform a validation and authentication routine prior to the exchange of data and information to provide account verification and security for access by the electronic device to a specific one or more collaborative shopping data 234 of an affiliated one or more collaborative shopping group 233.

Online shopping server 182 can host one or more third party shopping applications 241 that provide access to goods and services. Online shopping server 182 includes storage 240, such as one or more hard drives or solid state drives. Storage 240 can store online shopping application 241. In one embodiment, when a member of a collaborative shopping group views one or more items for acquisition, via online shopping application 241 of online shopping server 182, a respective electronic device (e.g., electronic device 100) can track an item review context that includes at least one previously-viewed item that is tracked within a collaborative shopping group context, and the electronic device can transmit the item review context, including the at least one previously-viewed item to application computer system 180.

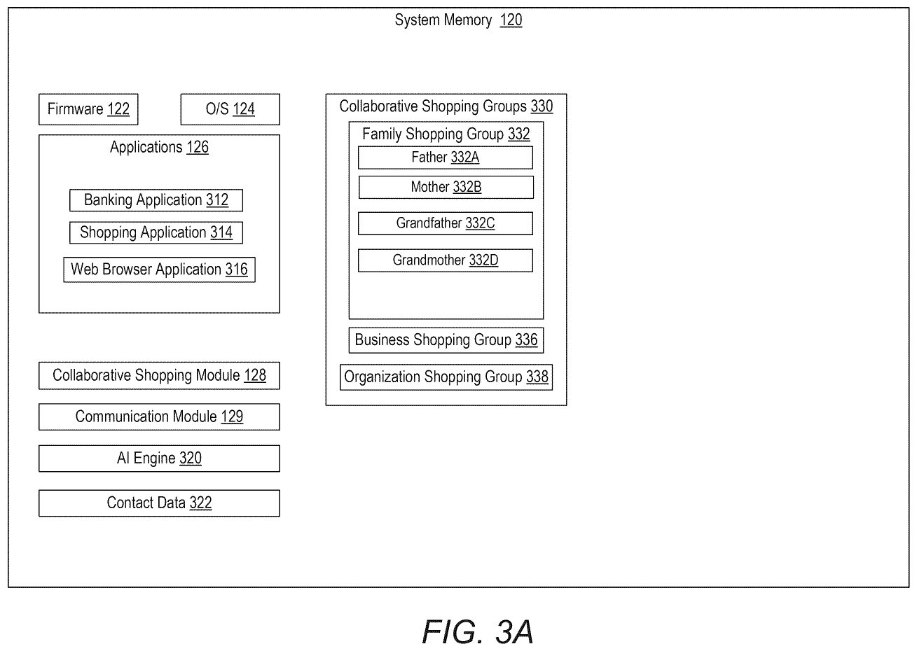

Referring to FIG. 3A, there is shown one embodiment of example contents of system memory 120 of electronic device 100 configured to complete the various processes described herein. System memory 120 includes data, software, and/or firmware modules, including firmware 122, an operating system (O/S) 124, applications 126, collaborative shopping (CS) module 128, and communication module 129. Applications 126 include banking application 312, shopping application 314, and web browser application 316. Banking application 312 includes program code that is executed by processor 102 to enable electronic device 100 to access banking services provided by a bank or other financial institution, such as a credit card company, online payment service, etc. Shopping application 314 includes program code that is executed by processor 102 to enable electronic device 100 to access websites to view, browse, and buy products or services from a retailer or service provider. Web browser application 316 includes program code that is executed by processor 102 to enable electronic device 100 to access various websites of the Internet. While applications 126 are shown to include three applications, applications 126 can include more or fewer than three applications.

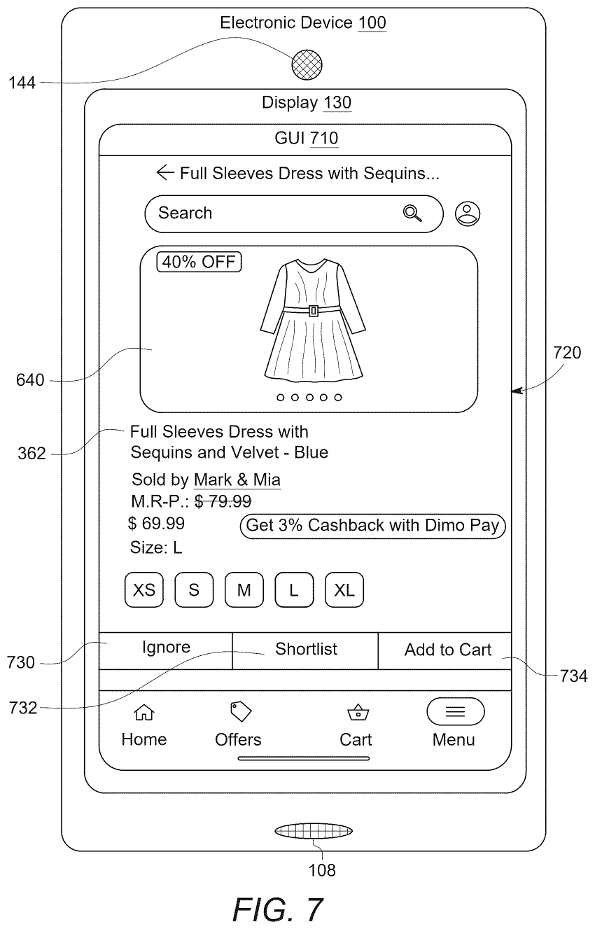

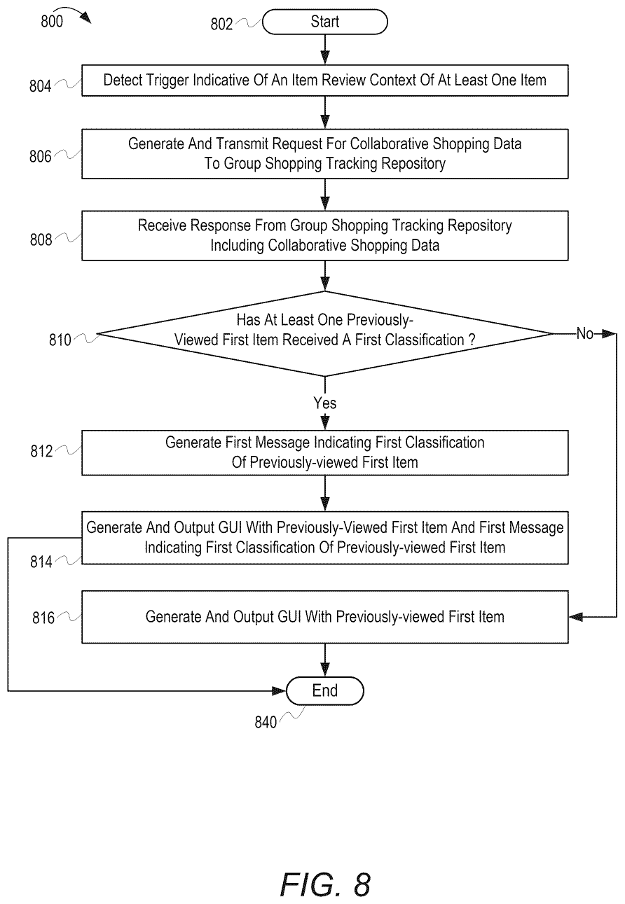

Collaborative shopping module 128 each includes program code that is executed by processor 102 to enable electronic device 100 to perform the various features of the present disclosure. In one or more embodiments, collaborative shopping module 128 enables electronic device 100 to coordinate browsing, viewing, and acquisition of at least one item, among members of a collaborative shopping group. In one or more embodiments, execution of collaborative shopping module 128 by processor 102 configures electronic device 100 to perform the processes presented in the flowcharts of FIGS. 7 and 8, as will be described below. Communication module 129 enables electronic device 100 to communicate and exchange data with other devices via wireless network 150 and/or WiFi router 196.

System memory 120 includes artificial intelligence (AI) engine 320 and contact data 322. AI engine 320 accelerates artificial intelligence, natural language processing (NLP), context evaluation (CE), and machine learning applications. Contact data 322 is a directory or list of known family members, friends and workers including e-mail addresses, messaging addresses and phone numbers.

System memory 120 includes one or more collaborative shopping groups 330. Collaborative shopping groups 330 are pre-determined groups of members that acquire items for a group of friends, family, business, or organization. Example collaborative shopping groups 330 include family collaborative shopping group 332, business collaborative shopping group 336, and organization shopping group 338. While three collaborative shopping groups are shown, collaborative shopping group 330 can have more or less than three collaborative shopping groups. Family collaborative shopping group 332 can include several family members, such as father 332A, mother 332B, grandfather 332C, and grandmother 332D. In one embodiment, business collaborative shopping group 336 can include at least a portion of the employees of a business or company. An organization shopping group 338 can include persons affiliated with an organization, such as a school or charity, who may not be personally connected otherwise.

Turning to FIG. 3B, there is shown additional details of example contents of system memory 120 of electronic device 100 configured to complete the various processes described herein. System memory 120 includes collaborative shopping data 360 and short-list items 382. Electronic device 100 can receive collaborative shopping data 360 from application computer system 180. Collaborative shopping data 360 contains data and information about previously-viewed items that are shared and/or utilized by members of a group of individuals such as family shopping group 332.

Collaborative shopping data 360 includes first previously-viewed (PV) item 362, second previously-viewed item 366, and third previously-viewed item 370. While three previously-viewed items are shown in collaborative shopping data 360, collaborative shopping data 360 can have more or less than three previously-viewed items. First previously-viewed item 362 includes first item merchandise category and type 364A, first item name or identifier 364B, first item previous viewer(s) 364C, and first item classification(s) 364D.

First item merchandise category and type 364A identifies the product or merchandise category and type associated with the first previously-viewed item 362. In an example embodiment, if the first previously-viewed item is a dress, the merchandise category can be women's clothing. In another example embodiment, if the first previously-viewed item is running shoes, the merchandise category can be footwear. First item identifier 364B is the name of the second item. First item previous viewer(s) 364C are the identities of members of the collaborative shopping group that have viewed the first previously-viewed item. First item classification(s) 364D are classifications about the first previously-viewed item 362 that either have been provided by a previous viewer or have been determined by electronic device 100 based on a previous viewer's viewing habits.

First item classification(s) 364D include first item viewer/classification A 364E, and first item viewer/classification B 364F. Examples of first item viewer/classifications A 364E or B 364F can include a member of the collaborative shopping group (1) viewed the first item, (2) ignored the first item, (3) rejected the first item, (4) added the first item to a short list of possible items for purchase, and (5) added the first item to an online shopping cart.

Second previously-viewed item 366 includes second item merchandise category and type 368A, second item name or identifier 368B, second item previous viewer(s) 368C, and second item classification(s) 368D. Second item classification(s) 368D include second item viewer/classification A 368E and second item viewer/classification B 368F.

Third previously-viewed item 370 includes third item merchandise category and type 372A, third item name or identifier 372B, third item previous viewer(s) 372C, and third item classification(s) 372D. Third item classification(s) 372D include third item viewer/classification A 372E and third item viewer/classification B 372F.

Short-list items 382 are possible items for acquisition that one or more members of a collaborative shopping group have identified as an item for possible purchase/acquisition and have added to the short-list. In one embodiment, short-list items 382 can be viewed by members of the collaborative shopping group.

System memory 120 further includes viewing time threshold 380 and viewing time 384. Viewing time threshold 380 is a pre-determined time value of a viewing time of an item, that when exceeded, indicates that a group shopping member has reviewed and/or performed due diligence on an item. Viewing time 384 is the actual amount of time an item has been viewed by a user.

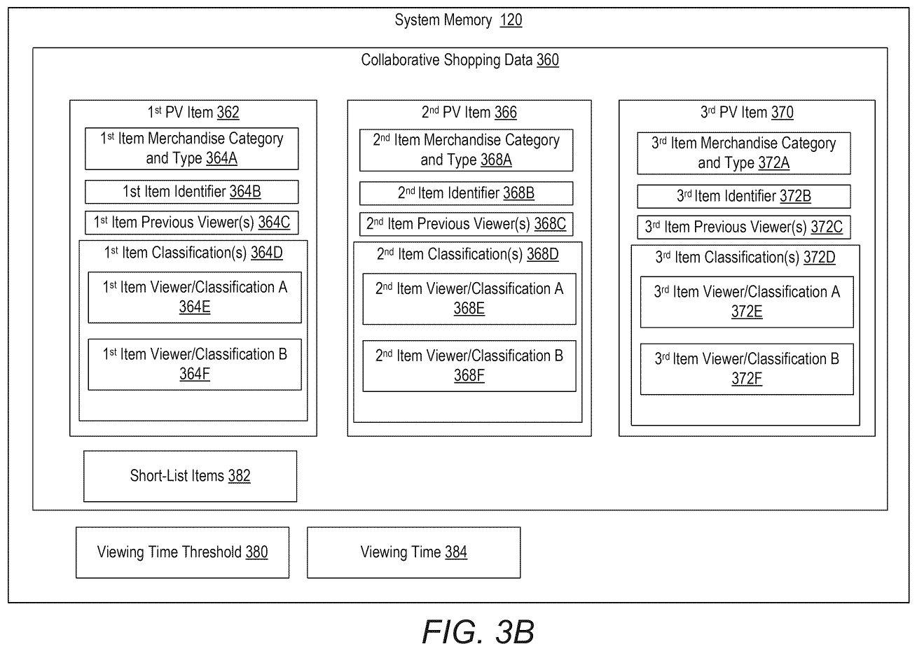

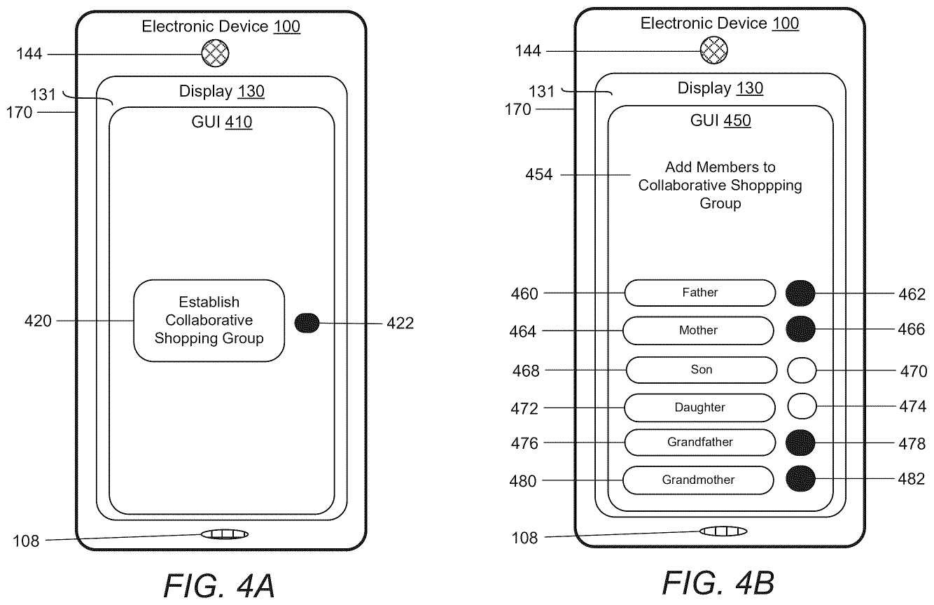

With reference to FIG. 4A, electronic device 100 is shown with an example collaborative shopping group setup (CSGS) graphical user interface (GUI) 410 presented on display 130. CSGS GUI 410 allows a user of electronic device 100 to set-up a collaborative shopping group. CSGS GUI 410 also allows the user to add/edit members, characteristics, list of group items, etc., of the collaborative shopping group. CSGS GUI 410 includes establish collaborative shopping group option 420, with option on/off indication 422. When selected, establish collaborative shopping group option 420 enables electronic device 100 to initiate processes to establish the collaborative shopping group.

With reference to FIG. 4B, electronic device 100 is shown with an example second graphical user interface (GUI) 450 presented on display 130 for adding members to a collaborative shopping group. Collaborative shopping group member update/add (CSGMU) GUI 450 is presented after a user has selected establish collaborative shopping group option 420 of FIG. 4A. CSGMU GUI 450 includes a description 454 of the purpose of GUI 450 and several user selectable options to add family members to a collaborative family shopping group.

Specifically, CSGMU GUI 450 includes several labeled options for each family member with associated on/off indicators that indicate when/whether a specific family member has been added to family shopping group 332 (FIG. 3A). CSGMU GUI 450 includes father selection option 460, with option on/off indication 462. CSGMU GUI 450 also includes mother selection option 464, with option on/off indication 466. CSGMU GUI 450 further includes son selection option 468, with option on/off indication 470, daughter selection option 472, with option on/off indication 474, grandfather selection option 476, with option on/off indication 478, and grandmother selection option 480, with option on/off indication 482. As provided by the example illustration, collaborative family shopping group 332 includes father, mother, grandfather, and grandmother, with respective indications on (darkened or checked). Notably, collaborative family shopping group 332 does not include either of the listed children. It is appreciated that the labels for each of the selectable members can be the actual names of the individuals as taken from the stored contact data 322 or inputted locally by the user within CSGMU GUI 450. Also, other family members can also be manually added.

According to one aspect of the disclosure, electronic device 100 can present CSGS GUI 410 on display 130. CSGS GUI 410 includes a user-selectable option 420 to establish a collaborative shopping group. The collaborative shopping group includes two or more individual members whose individual online shopping activities and/or viewing of items are tracked within the collaborative shopping data. In response to detecting selection of the user-selectable option 420, electronic device 100 initiates processes to establish the collaborative shopping group.

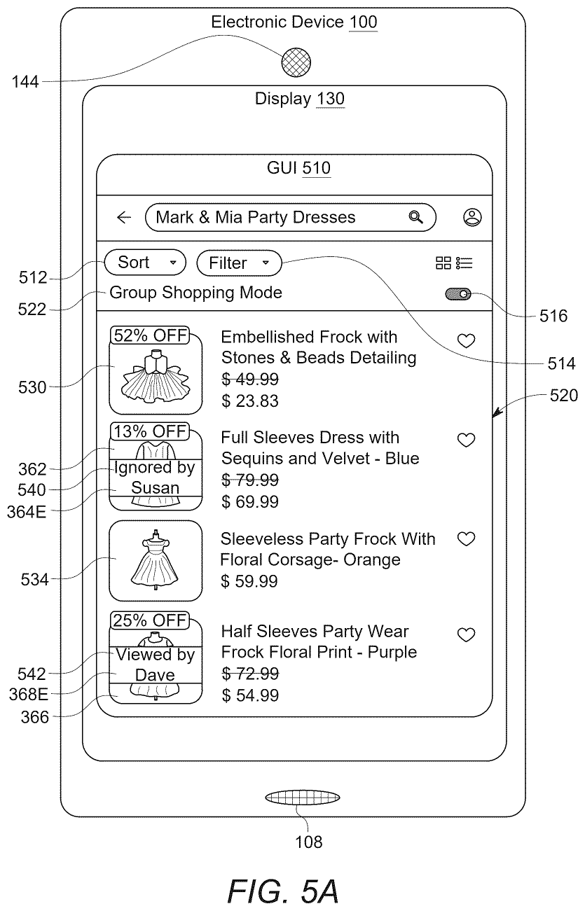

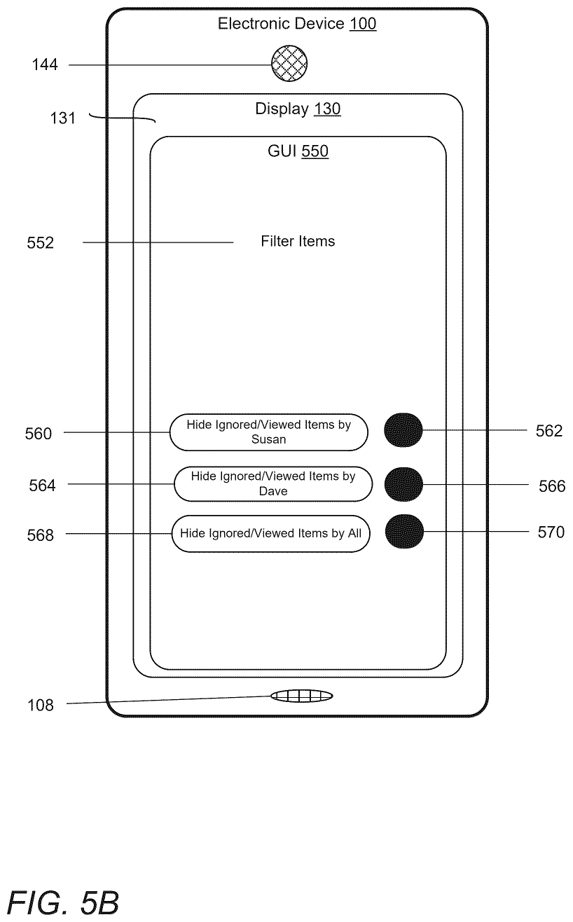

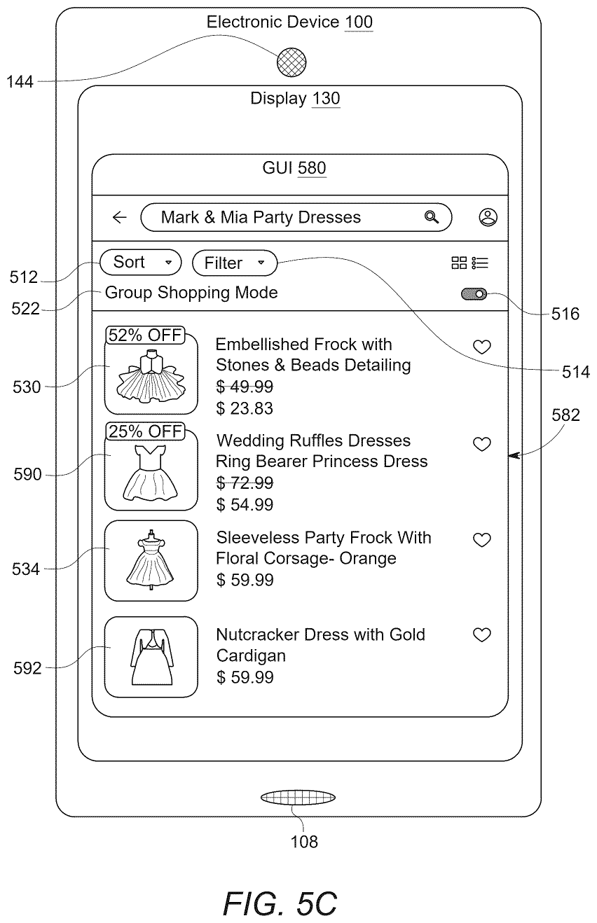

With reference to FIG. 5A, electronic device 100 is shown with an example online item selection (OIS) graphical user interface (GUI) 510 presented on display 130 for reviewing and selecting items for possible acquisition by members of a collaborative shopping group. OIS GUI 510 allows a user of electronic device 100 to review and/or select/purchase goods and services from a merchant. In one embodiment, electronic device 100 can access a shopping website using shopping application 314 executing on processor 102. In one embodiment, OIS GUI 510 can result from a user of electronic device 100 searching an online shopping website for one or more desired items within a desired merchandise category and type (e.g., 1^{st} item merchandise category and type 364A).

OIS GUI 510 includes a sort selection option 512, a filter selection option 514, a group shopping selection option 516, and an online item selection interface page 520 that includes an item review context of several items or products that have been searched for/reviewed by at least one user. Sort selection option 512, when selected, sorts items within online item selection interface page 520 according to one or more selected criteria. Filter selection option 514, when selected, filters items within online item selection interface page 520 according to one or more selected criteria. Group shopping selection option 516, when selected/toggled, enables group shopping mode 522. In FIG. 5A, group shopping selection option 516 is shown in an “on” or enabled position.

Online item selection interface page 520 includes item A 530, first previously-viewed item 362, item B 534, and second previously viewed item 366. In one embodiment, a husband and wife can be searching for a party dress to purchase as a birthday present/gift for a child, and items 530, 362, 534, and 366 can be at least a portion of items that have resulted from an online shopping search. Some of the items within online item selection interface page 520 include a message or notification that the item has been previously viewed by a member of the collaborative shopping group and has received at least one classification. Items 530, 362, 534, and 366 include a product description and price for each item.

First previously-viewed item 362 includes a message 540 that indicates a viewer/classification 364E of the previously-viewed item. In one embodiment, message 540 can be presented concurrently with presenting item 362 on display 130. In FIG. 5A, message 540 indicates that item 362 has received a classification by Susan of being ignored. In one embodiment, a classification of “ignore” can indicate that an item has been explicitly labeled with a classification of “ignore” by a member of the collaborative shopping group. In another embodiment, a classification of “ignore” can indicate that an item has been viewed by a member of the collaborative shopping group and has not been added to a short list of possible items for purchase. In this latter embodiment, the AI engine 103E/320 tags the item as ignore within the collaborative shopping database.

Second previously-viewed item 366 includes a message 542 that indicates a viewer/classification 368E of the previously-viewed item. In one embodiment, message 542 can be presented concurrently with presenting item 366 on display 130. In FIG. 5A, message 542 indicates that item 366 has received a classification by Dave of being viewed. In one embodiment, a classification of “viewed” can indicate that an item has been reviewed and/or considered by a member of the collaborative shopping group longer than viewing time threshold 380.

According to one aspect of the disclosure, electronic device 100 can detect a trigger indicative of an item review context that includes a presentation of at least one first item (e.g., item A 530) having a first merchandise category tracked within a collaborative shopping group context. In response to detecting the trigger, electronic device 100 retrieves collaborative shopping data 360 corresponding to at least one previously-viewed first item 362. Electronic device 100 determines if the at least one previously-viewed first item 362 has received a first classification 364E by at least one member of a collaborative shopping group 330. In response to the previously-viewed first item 362 having received the first classification 364E, electronic device 100 outputs a first message 540 concurrently with presenting the at least one first item, the first message indicating the first classification 364E of the at least one previously-viewed first item 362.

According to another aspect of the disclosure, electronic device 100 includes at least one output device that comprises a display 130 and, to output the first message 540, electronic device 100 outputs a first graphical user interface (GUI) 510 on the display. The first GUI includes an online item selection interface page 520 comprising a representation of the at least one previously-viewed first item 362, and the first message 540 visually indicates the first classification of the at least one previously-viewed first item.

According to an additional aspect of the disclosure, to detect the trigger, electronic device 100 detects initiation of at least one shopping application 314 presenting access to items having the common merchandise category with the at least one first item.

Turning to FIG. 5B, electronic device 100 is shown with an example filter selection (FS) graphical user interface (GUI) 550 presented on display 130 after filter option 514 of FIG. 5B has been selected. FS GUI 550 enables a user to select one or more filter types to be applied to items of online item selection interface page 520 in order to remove items with a certain classification by at least one member of a collaborative shopping group. FS GUI 550 includes a description 552 of FS GUI 550 and several user selectable options to select a filter type. Each selectable option has an associated on/off indication that toggles on when the listed item/category is selected.

FS GUI 550 includes hide ignored/viewed items by Susan option 560, with option on/off indication 562, hide ignored/viewed items by Dave option 564, with option on/off indication 566, and hide ignored/viewed items by all members of the collaborative shopping group option 568, with option on/off indication 570. In FIG. 5B, hide ignored/viewed items by Susan option 560, hide ignored/viewed items by Dave option 564, and hide ignored/viewed items by all members of the collaborative shopping group option 568 have been selected with respective option on/off indications 562, 566, and 570 filled in or checked.

Turning to FIG. 5C, electronic device 100 is shown with an example online item selection after filtering (OISAF) graphical user interface (GUI) 580 presented on display 130. OISAF GUI 580 includes the items remaining on online item selection interface page 520 after the filter types of FIG. 5B have been applied. OISAF GUI 580 includes modified online item selection interface page 582.

Modified online item selection interface page 582 includes item A 530, item E 590, item C 534, and item F 592. In FIG. 5C, the items that were classified as being either ignored (e.g., item 362) or viewed (e.g., item 366) have been removed from the page. The items that were removed have been replaced with items (e.g., item E 590, item F 592) that were the result of an online search for a desired merchandise category and type.

According to one aspect of the disclosure, first item 530 is among a plurality of similar items (e.g., items 362, 534, and 366) within a first merchandise category. Electronic device 100 can present, within an online item selection interface page 520, a user-selectable option 514 to filter the plurality of similar items based on a first classification for each item in the plurality of similar items (e.g., classification 364D for item 362, classification 368D for item 366). In response to detecting selection of the user-selectable option 514, electronic device 100 identifies, from the collaborative shopping data 360, a first set of items (e.g., items 362, 366) from among the plurality of items that have the first classification. Electronic device 100 removes the first set of items from the plurality of items to obtain a remaining set of items. Electronic device 100 renders a modified online item selection interface page 582 comprising the remaining set of items and outputs the modified online item selection interface page on display 130 to present the remaining set of items.

According to another aspect of the disclosure, first item 530 is among a plurality of similar items within a first merchandise category. Electronic device 100 can present, within an online item selection interface page 520 a user-selectable option 514 to filter the plurality of similar items based on a second classification 364F. In one embodiment, the second classification 364F can be that the item has been added to short list items 382. In response to detecting selection of the user-selectable option 514, electronic device 100 identifies, from the collaborative shopping data 360, a first set of items (e.g., items 530, 590, 534, 592) from among the plurality of items that have the second classification. Electronic device 100 renders a modified online item selection interface page 582 comprising the first set of items and outputs the modified item selection interface page on display 130 to present the first set of items that have the second classification.

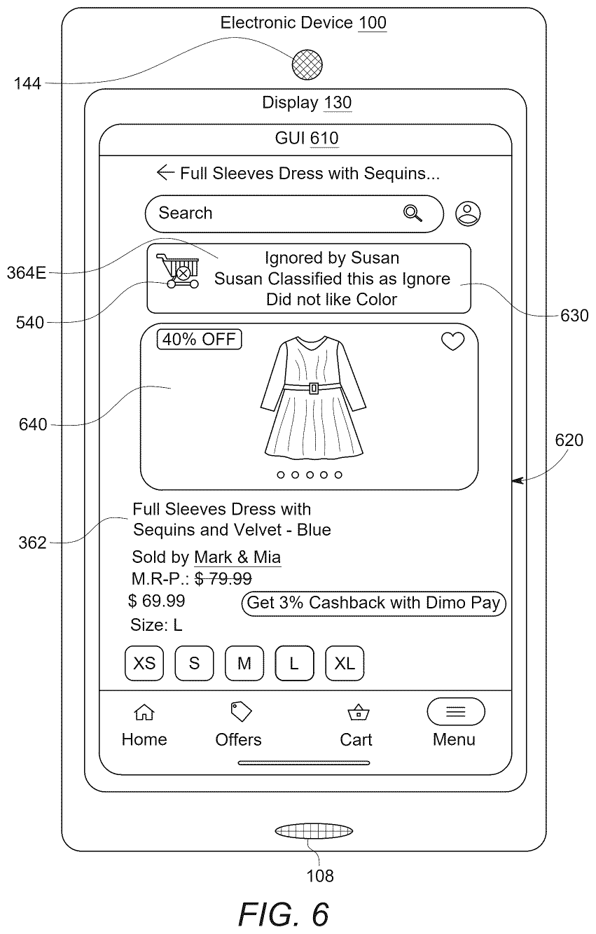

Referring to FIG. 6, electronic device 100 is shown with an example online item selection product page (OISPP) graphical user interface (GUI) 610 presented on display 130 for reviewing details and selecting an item for possible acquisition by members of a collaborative shopping group. In one embodiment, OISPP GUI 610 can be presented after a user has selected a specific item (e.g., item 362) from OIS GUI 510 (FIG. 5A).

OISPP GUI 610 includes an online item selection interface product page 620. Online item selection interface product page 620 includes first previously-viewed item 362, at least one image 640 of the first previously-viewed item 362, and message 540 that indicates a viewer/classification 364E of the previously-viewed item. Message 540 also includes an item context 630. Item context 630 can include additional details as to the classification included with the message. In one example embodiment, item context 630 can include one or more reasons why an item was ignored or was not selected as a possible item for acquisition. In an example embodiment, item context 630 can be that a previous viewer did not like the color of the item.

According to one aspect of the disclosure, message 540 includes the viewer/classification 364E of the at least one previously viewed first item 362 and a first context 630 associated with the viewer/classification.

Referring to FIG. 7, electronic device 100 is shown with an example classification selection (CS) graphical user interface (GUI) 710 presented on display 130. CS GUI 710 enables a user to select one or more classifications for at least one item (e.g., item 362). CS GUI 710 includes an online item classification selection page 720 and several user selectable options to select a classification for the item.

CS GUI 710 includes ignore option 730, short-list option 732, and add to cart option 734. Ignore option 730, when selected, identifies or classifies item 362 with an “ignore” classification (e.g., first viewer/classification A 364E) for a respective viewer of the item. Short-list option 732, when selected, identifies or classifies item 362 with a “short-list” classification (e.g., first viewer/classification B 364F) for a respective viewer of the item and adds item 362 to short-list items 382. Add to cart option 734, when selected, classifies item 362 with an “added to shopping cart” classification and adds item 362 to an online shopping cart.

According to one aspect of the disclosure, electronic device 100 can present, within online item classification interface page 720 comprising the at least one first item 362, a first user-selectable option (e.g., ignore option 730) to add a second classification for the at least one first item 362. In response to detecting selection of the first user-selectable option, electronic device 100 receives entry of the second classification and updates the collaborative shopping data 360 with the second classification of the at least one first item 362 provided by a current member of the collaborative shopping group 330. Electronic device 100 stores the updated collaborative shopping data 360 to a group shopping tracking repository 230.

According to another aspect of the disclosure, electronic device 100 can track a viewing time 384 of at least one second item 366 by a first user of the electronic device and determine if the viewing time of the at least one second item is greater than a viewing time threshold 380. In response to determining that the viewing time 384 of the at least one second item is greater than the viewing time threshold 380, electronic device 100 identifies a second classification 368F for the at least one second item. The second classification indicates that the second item has been viewed by the first user longer than the viewing time threshold, which indicates that the first user has considered the at least one second item. Electronic device 100 updates the collaborative shopping data 360 with the second classification of the at least one second item and stores the updated collaborative shopping data.

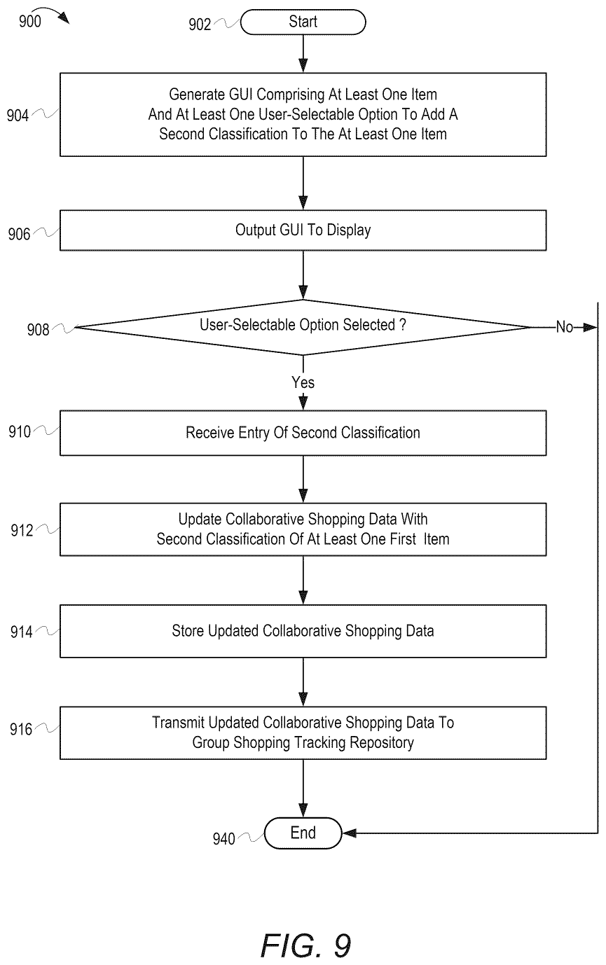

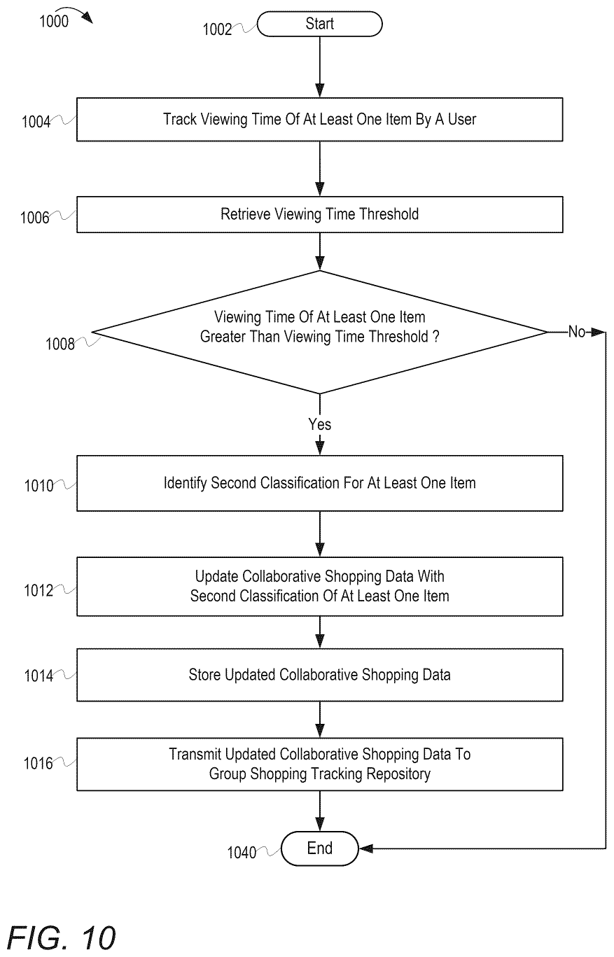

FIG. 8 depicts method 800 by which electronic device 100 coordinates shopping and reviewing of items with members of a collaborative shopping group and generates notifications about at least one item. FIG. 9 depicts method 900 by which electronic device 100 receives a selection by a user of at least one classification of a viewed item and updates a collaborative shopping database with the classification of the viewed item. FIG. 10 depicts method 1000 by which electronic device 100 tracks a viewing time of at least one item by a user and identifies a classification for the item, based on the viewing time being greater than a viewing time threshold.

The description of methods 800, 900 and 1000 will be described with reference to the components and examples of FIGS. 1-7. The operations depicted in FIGS. 8-10 can be performed by electronic device 100 or any suitable electronic device that includes the one or more functional components of electronic device 100 that provide/enable the described features. One or more of the processes of the methods described in FIGS. 8-10 may be performed by processor 102 executing program code associated with collaborative shopping module 128.

With specific reference to FIG. 8 method 800 begins at start block 802. At block 804, method 800 includes detecting a trigger that is indicative of an item review context that includes a presentation of at least one first item (e.g., item A 530) having a first merchandise category tracked within a collaborative shopping group context. In response to detecting the trigger, method 900 includes generating and transmitting a request 260 to group shopping tracking repository 230 for collaborative shopping data 234 with at least one previously-viewed item that has been viewed by a member of a collaborative shopping group (block 806). Method 900 includes receiving a response 262 from group shopping tracking repository 230 including the collaborative shopping data 234 (block 808). The received collaborative shopping data 234 is stored as collaborative shopping data 360 to system memory 120.

At decision block 810, method 800 includes determining if at least one previously-viewed first item 362 has received a first classification 364E by at least one member of the collaborative shopping group 330. In response to the previously-viewed first item 362 not having received the first classification 364E, method 800 includes generating and outputting a GUI, to display 130, to present the at least one previously-viewed first item 362 (block 816). Method 800 terminates at end block 840.

In response to the previously-viewed first item 362 having received the first classification 364E, method 800 includes generating a first message 540 indicating the first classification 364E of the at least one previously-viewed first item 362 (block 812). Method 800 includes generating and outputting a GUI 510, to display 130, including the first message 540 concurrently with presenting at least one previously-viewed first item 362 (block 814). The first message indicates the first classification 364E of the at least one previously-viewed first item 362. Method 800 terminates at end block 840.

FIG. 9 depicts method 900 by which electronic device 100 receives a selection by a user of at least one classification of a viewed item and updates a collaborative shopping database with the classification of the viewed item. With specific reference to FIG. 9, method 900 begins at the start block 902. At block 904, method 900 includes generating GUI 710 comprising at least one item 362 and at least one user-selectable option (e.g., ignore option 730) to add a second classification 364F for the at least one item 362 by a member of a collaborative shopping group. Generating GUI 710 can include generating an online item classification selection interface page 720 comprising the at least one item and the user-selectable option. Method 900 includes outputting GUI 710 to display 130 (block 906).

Method 900 includes determining if the at least one user-selectable option (e.g., ignore option 730) has been selected (decision block 908). In response to determining that the at least one user-selectable option (e.g., ignore option 730) has not been selected, method 900 ends at end block 940. In response to detecting or determining that the at least one user-selectable option (e.g., ignore option 730) has been selected, method 900 includes receiving entry of the second classification 364F (block 910) and updating the collaborative shopping data 360 with the second classification 364F of the at least one item 362 provided by a current member (i.e., current viewer) of the collaborative shopping group 330 (block 912).

Method 900 includes storing the updated collaborative shopping data 360 to system memory 120 (block 914) and transmitting the updated collaborative shopping data 360 to group shopping tracking repository 230 (block 916). Method 900 terminates at end block 940.

FIG. 10 depicts method 1000 by which electronic device 100 tracks a viewing time of at least one item by a user and identifies a classification for the item, based on the viewing time being greater than a viewing time threshold. With specific reference to FIG. 10, method 1000 begins at the start block 1002. At block 1004, method 1000 includes tracking a viewing time 384 of at least one item (e.g., item 366) by a user of electronic device 100. In one embodiment, viewing time 384 is the length of time that an item is shown on display 130. Method 1000 includes retrieving viewing time threshold 380 from system memory 120 (block 1006).

Method 1000 includes determining if the viewing time 384 of the at least one item is greater than viewing time threshold 380 (decision block 1008). In response to determining that the viewing time 384 of the at least one item is not greater than viewing time threshold 380, method 1000 ends at end block 1040. In response to determining that the viewing time 384 of the at least one item is greater than viewing time threshold 380, method 1000 includes identifying a second classification 368F for the at least one item, (block 1010). The second classification indicates that the item has been viewed by a user longer than the viewing time threshold, which indicates that the first user has considered/reviewed the at least one item.

Method 1000 includes updating the collaborative shopping data 360 with the second classification 368F of the at least one item (block 1012). Method 1000 includes storing the updated collaborative shopping data 360 to system memory 120 (block 1014) and transmitting the updated collaborative shopping data 360 to group shopping tracking repository 230 (block 1016). Method 1000 terminates at end block 1040.

Accordingly, the disclosure enables the coordination of group shopping with members of a collaborative shopping group to review and/or acquire at least one item or service and generate notifications about the at least one item or service. The disclosure enables a user of an electronic device to view classifications of previously-viewed items that are provided and/or attributed to other members of the collaborative shopping group who have viewed at least one previously-viewed item. The disclosure enables a user to select one or more classifications to filter a plurality of similar items based on the selected classifications. The disclosure enables a user to select one or more classifications for at least one item and to store the item classifications to a group shopping tracking repository. Accordingly, the disclosure helps to eliminate situations where a same item is individually reviewed by different members of a group without knowledge that the other members have already reviewed the item. The disclosure provides benefits of time saving for the collective group and efficiency in identifying items suitable for purchase.

In the above-described methods of FIGS. 8-10, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system. ” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals; but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
at least one output device;
a communications subsystem that enables the electronic device to connect to external networks and devices;
a memory having stored thereon a collaborative shopping module for coordinating shopping and generating notifications about at least one item; and
at least one processor communicatively coupled to each of the at least one output device, the communications subsystem, and the memory, and which executes program code of the collaborative shopping module, the at least one processor configured to cause the electronic device to:
detect a trigger indicative of an item review context that includes a presentation of at least one first item having a first merchandise category tracked within a collaborative shopping group context;
in response to detecting the trigger, retrieve collaborative shopping data corresponding to at least one previously-viewed first item;
determine if the at least one previously-viewed first item has received a first classification by at least one member of a collaborative shopping group; and
in response to the previously-viewed first item having received the first classification, output a first message concurrently with presenting the at least one first item, the first message indicating the first classification of the at least one previously-viewed first item.

2. The electronic device of claim 1, wherein the at least one processor is configured to:
generate a request for the collaborative shopping data;
transmit the request for the collaborative shopping data to a group shopping tracking repository; and
receive, from the group shopping tracking repository, the collaborative shopping data.

3. The electronic device of claim 1, wherein the at least one output device comprises a display and to output the first message, the at least one processor is configured to:
output a first graphical user interface (GUI) on the display, the first GUI including an online item selection interface comprising a representation of the at least one first item and the first message visually indicating the first classification of the at least one previously-viewed first item.

4. The electronic device of claim 3, wherein the at least one processor is configured to:
present within the online item selection interface comprising the at least one first item, a first user-selectable option to add a second classification for the at least one first item; and
in response to detecting selection of the first user-selectable option:
receive entry of the second classification;
update the collaborative shopping data with the second classification of the at least one first item provided by a current member of the collaborative shopping group; and
store the updated collaborative shopping data to a group shopping tracking repository.

5. The electronic device of claim 3, wherein:
the at least one first item is among a plurality of similar items within the first merchandise category; and
the at least one processor is configured to:
present within the online item selection interface a second user-selectable option to filter the plurality of similar items based on the first classification; and
in response to detecting selection of the second user-selectable option:
identify, from the collaborative shopping data, a first set of items from among the plurality of items that have the first classification;
remove the first set of items from the plurality of items to obtain a remaining set of items;
render a modified online item selection interface comprising the remaining set of items on the display; and
output the modified online item selection interface on the display to present the remaining set of items.

6. The electronic device of claim 3, wherein:
the at least one first item is among a plurality of similar items within the first merchandise category; and
the at least one processor is configured to:
present a third user-selectable option to filter a plurality of items shown on the online item selection interface based on a second classification; and
in response to detecting selection of the third user-selectable option:
identify, from the collaborative shopping data, a first set of items from among the plurality of similar items that have the second classification;
render a modified item selection interface comprising the first set of items; and
output the modified item selection interface on the display to present the first set of items that have the second classification.

7. The electronic device of claim 1, wherein the at least one output device comprises a display and the at least one processor is configured to:
present a collaborative shopping group (CSG) setup graphical user interface (GUI) on the display, the CSG setup GUI comprising a fourth user-selectable option to establish the collaborative shopping group including at least two members whose individual online shopping activities are tracked within the collaborative shopping data; and
in response to detecting selection of the fourth user-selectable option, initiate processes to establish the collaborative shopping group.

8. The electronic device of claim 1, wherein to detect the trigger, the at least one processor is configured to:
detect initiation of at least one shopping application presenting access to items having a common merchandise category with the at least one first item.

9. The electronic device of claim 1, wherein the at least one processor is configured to:
track a viewing time of at least one second item by a first user of the electronic device;
determine if the viewing time of the at least one second item is greater than a viewing time threshold;
in response to determining that the viewing time of the at least one second item is greater than the viewing time threshold, identify a second classification for the at least one second item, the second classification indicating that the second item has been viewed by the first user longer than the viewing time threshold, which indicates that the first user has considered the at least one second item;
update the collaborative shopping data with the second classification of the at least one second item; and
store the updated collaborative shopping data.

10. The electronic device of claim 1, wherein the first message includes the first classification of the at least one previously-viewed first item and a first context associated with the at least one first classification.

11. A method comprising:
detecting, via at least one processor of an electronic device, a trigger indicative of an item review context that includes a presentation of at least one first item having a first merchandise category tracked within a collaborative shopping group context;
in response to detecting the trigger, retrieving collaborative shopping data corresponding to at least one previously-viewed first item;
determining if the at least one previously-viewed first item has received a first classification by at least one member of a collaborative shopping group; and
in response to the previously-viewed first item having received the first classification, outputting a first message concurrently with presenting the at least one first item, the first message indicating the first classification of the at least one previously-viewed first item.

12. The method of claim 11, further comprising:
generating a request for the collaborative shopping data;
transmitting the request for the collaborative shopping data to a group shopping tracking repository; and
receiving, from the group shopping tracking repository, the collaborative shopping data.

13. The method of claim 11, wherein the electronic device further comprises a display and to output the first message, the method further comprises:
outputting a first graphical user interface (GUI) on the display, the first GUI including an online item selection interface comprising a representation of the at least one first item and the first message visually indicating the first classification of the at least one previously-viewed first item.

14. The method of claim 13, further comprising:
presenting within the online item selection interface comprising the at least one first item, a first user-selectable option to add a second classification for the at least one first item; and
in response to detecting selection of the first user-selectable option:
receiving entry of the second classification;
updating the collaborative shopping data with the second classification of the at least one first item provided by a current member of the collaborative shopping group; and
storing the updated collaborative shopping data to a group shopping tracking repository.

15. The method of claim 13, wherein the at least one first item is among a plurality of similar items within the first merchandise category, the method further comprising:
presenting within the online item selection interface a second user-selectable option to filter the plurality of similar items based on the first classification; and
in response to detecting selection of the second user-selectable option:
identifying, from the collaborative shopping data, a first set of items from among the plurality of items that have the first classification;
removing the first set of items from the plurality of items to obtain a remaining set of items;
rendering a modified online item selection interface comprising the remaining set of items on the display; and
outputting the modified online item selection interface on the display to present the remaining set of items.

16. The method of claim 13, wherein the at least one first item is among a plurality of similar items within the first merchandise category, the method further comprising:
presenting a third user-selectable option to filter a plurality of items shown on the online item selection interface based on a second classification; and
in response to detecting selection of the third user-selectable option:
identifying from the collaborative shopping data, a first set of items from among the plurality of similar items that have the second classification;
rendering a modified item selection interface comprising the first set of items; and
outputting the modified item selection interface on the display to present the first set of items that have the second classification.

17. The method of claim 11, wherein the electronic device further comprises a display, the method further comprising:
presenting a collaborative shopping group (CSG) setup graphical user interface (GUI) on the display, the CSG setup GUI comprising a fourth user-selectable option to establish the collaborative shopping group including at least two members whose individual online shopping activities are tracked within the collaborative shopping data; and
in response to detecting selection of the fourth user-selectable option, initiating processes to establish the collaborative shopping group.

18. The method of claim 11, wherein to detect the trigger, the method further comprises:
detecting initiation of at least one shopping application presenting access to items having a common merchandise category with the at least one first item.

19. The method of claim 11, further comprising:
tracking a viewing time of at least one second item by a first user of the electronic device;
determining if the viewing time of the at least one second item is greater than a viewing time threshold;
in response to determining that the viewing time of the at least one second item is greater than the viewing time threshold, identifying a second classification for the at least one second item, the second classification indicating that the second item has been viewed by the first user longer than the viewing time threshold, which indicates that the first user has considered the at least one second item;
updating the collaborative shopping data with the second classification of the at least one second item; and
storing the updated collaborative shopping data.

20. A computer program product comprising:
a computer readable storage device having stored thereon program code which, when executed by at least one processor of an electronic device having at least one output device, and a communications subsystem, configures the electronic device to complete the functionality of:
detecting a trigger indicative of an item review context that includes a presentation of at least one first item having a first merchandise category tracked within a collaborative shopping group context;
in response to detecting the trigger, retrieving collaborative shopping data corresponding to at least one previously-viewed first item;
determining if the at least one previously-viewed first item has received a first classification by at least one member of a collaborative shopping group; and
in response to the previously-viewed first item having received the first classification, outputting a first message concurrently with presenting the at least one first item, the first message indicating the first classification of the at least one previously-viewed first item.
